(19) United States
(12) Patent Application Publication
(10) Pub. No.: US 2012/0048693 A1
(43) Pub. Date: Mar. 1, 2012

(54) Mode Switch For Vehicle

(76) Inventors: Young-Jun Youn, Daegu (KR); Cheol-Min Park, Daegu (KR)

(21) Appl. No.: 13/222,562

(22) Filed: Aug. 31, 2011

(30) Foreign Application Priority Data
Aug. 31, 2010 (KR) 10-2010-0085051

(51) Int. Cl. H01H 1/36

(52) U.S. Cl. 200/252

(57) ABSTRACT

A mode switch for a vehicle is mounted on a power box having power terminals for connecting fuses mounted therein. The mode switch mode switch for a vehicle includes an outer housing, an actuator housing, an actuator, and a sliding contact. The actuator housing is mounted to the outer housing and includes a display. The actuator is mounted along an inside of the actuator housing and is movable between one side of the actuator housing to another side thereof. The actuator includes a terminal mounting portion therein, and the sliding contact is secured to the terminal mounting portion.

### FIELD OF INVENTION

The invention relates to a mode switch, and more particularly to a mode switch for repeatedly shutting off power in a motor vehicle.

### BACKGROUND

In general, when an electronic product is waiting to be sold or exported, it is necessary to separate a fuse of a power connector in order to prevent a battery from being discharged before actual use.

For example, when a vehicle is waiting for sale, a seller momentarily connects the fuse of the power connector during a trial run of the vehicle for a customer, and then separates the fuse of the power connector again during completion of the trial run.

Such a fuse is formed as a holder type. One side of the holder type fuse and the other side thereof separate from each other so that the other side of the fuse is inserted into or separated from one side of the fuse, which is fixed. As a result, a holder portion which is the other side of the fuse may be lost, and terminals of the fuse may also be damaged during insertion or separation of the holder portion.

To solve the above problems, the Japanese Laid-Open Utility-Model Publication No. H05-06647 (Title: Fuse Box), as shown in FIG. 7, discloses a known fuse with an upper plate 10 and a conductor receiving passageway 20 positioned through the upper plate 10, such that a main body 13 having a conductor 14 at a lower surface thereof is inserted into the conductor receiving passageway 20. The conductor receiving passageway 20 has sufficient size to allow the main body 13 to be moved from one side of the conductor receiving passageway 20 to the other side thereof.

Also, two contact points 15 and 16 are mounted at opposite sides in a lower surface of the upper plate 10 around the conductor receiving passageway 20.

Accordingly, when the main body 13 is positioned at one side of the conductor receiving passageway 20 to be connected with one contact point 16, the fuse of the power connector is disconnected. When the main body 13 is moved to another side of the conductor receiving passageway 20, the conductor 14 of the main body 13 is connected to both of the contact points 15 and 16, thereby connecting the fuse of the power connector.

In the known fuse described above, each of the contact points 15 and 16 is elastically deformed or bent. However, the elastic force of each contact point 15 or 16 is decreased as the main body 13 is repeatedly moved from one side of the conductor receiving passageway 20 to the other side thereof, thereby deforming or damaging the contact points 15 and 16. Consequently, poor connection between the conductor 14 of the main body 13 and the contact point 15 or 16 may occur.

Further, when the main body 13 is moved to one side of the conductor receiving passageway 20 or the other side thereof, a portion of the conductor receiving passageway 20 opposed to movement of the main body 13 is opened. Therefore, foreign material may be introduced through the opening of the conductor receiving passageway 20, thereby generating malfunction, such as a poor connection.

Also, when the main body 13 is urged, the main body 13 moves to one side of the conductor receiving passageway 20 or the other side thereof, in which the main body 13 either connects or disconnects with the contact points 15 and 16. However, a fixing device for maintaining connection or disconnection between the main body 13 and the contact points 15 and 16 is not present along the main body 13 or the conductor receiving passageway 20. As a result, the main body 13 moves through slight pressure, which creates unintended connection or disconnection between the main body 13 and the contact points 15 and 16.

### SUMMARY

Therefore, the present invention has been made in view of the above problems, and it is an object of the present invention to provide a mode switch for a vehicle capable of allowing a sliding contact connected with a power terminal to move laterally in order to connect or disconnect from a power terminal, applying or shutting off power, and minimizing deformation of the sliding contact.

The mode switch mode switch for a vehicle includes an outer housing, an actuator housing, an actuator, and a sliding contact. The actuator housing is mounted to the outer housing and includes a display. The actuator is mounted along an inside of the actuator housing and is movable between one side of the actuator housing to another side thereof. The actuator includes a terminal mounting portion therein, and the sliding contact is secured to the terminal mounting portion.

### BRIEF DESCRIPTION OF THE DRAWINGS

The above and other objects, features and other advantages of the present invention will be more clearly understood from the following detailed description taken in conjunction with the accompanying drawings, in which:

FIG. 1 is an exploded perspective view of a mode switch for a vehicle according the invention;

FIG. 2a is a perspective view of sliding contacts of the mode switch according to the invention;

FIG. 2b is a bottom view of the sliding contacts of the mode switch according to the invention;

FIG. 2c is a side view of the sliding contacts of the mode switch according to the invention;

FIG. 3 is an exploded perspective view of an outer housing and a actuator housing of a mode switch for the vehicle according to the invention;

FIG. 4a is a perspective close-up view of the mode switch for the vehicle according to the invention;

FIG. 4b is a sectional view of the mode switch for the vehicle according to the invention;

FIG. 5a is a top view of the mode switch for the vehicle according to the invention when power is shut off;

FIG. 5b is a sectional view of the mode switch for the vehicle according to the invention when power is shut off;

FIG. 5c is a front view of the mode switch for the vehicle according to the invention contacting select power terminals when power is shut off;

FIG. 6a is a top view of the mode switch for the vehicle according to the invention when power is supplied;

FIG. 6b is a sectional view of the mode switch for the vehicle according to the invention when power is supplied;

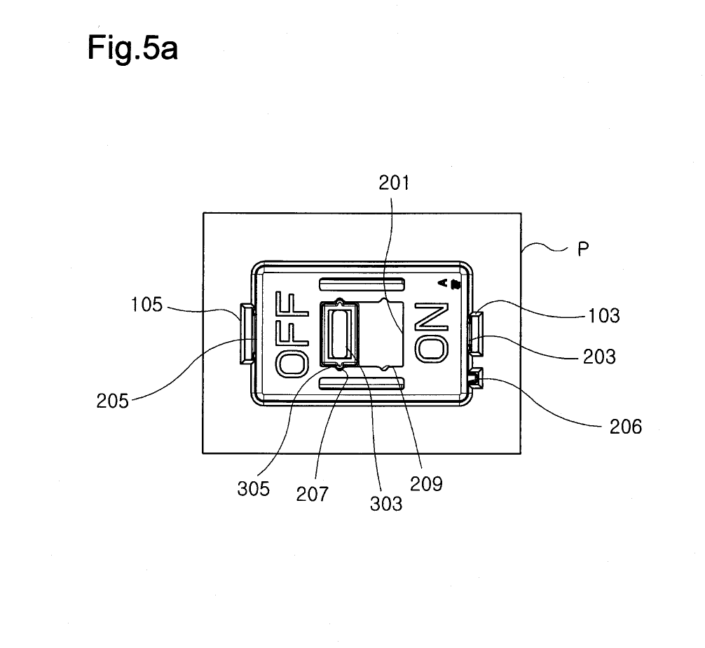

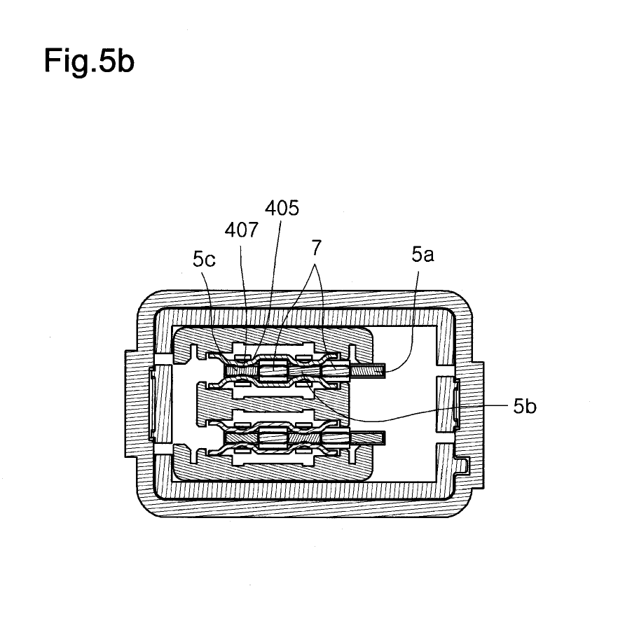

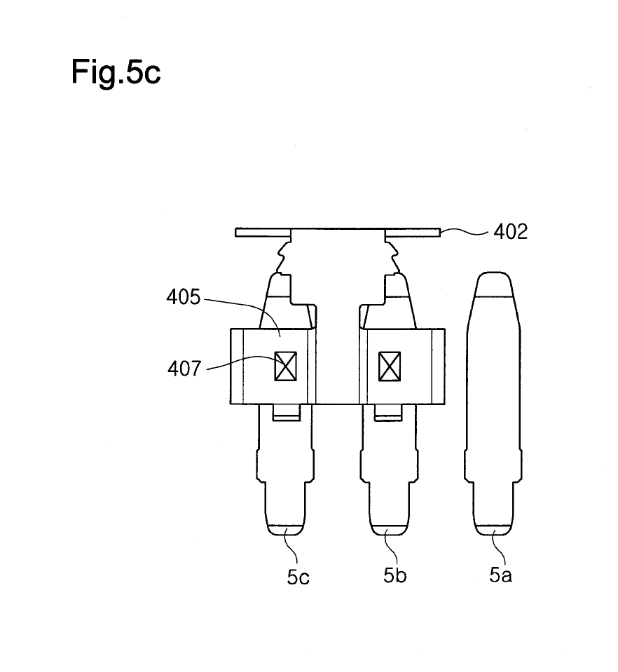

FIG. 5c is a front view of the mode switch for the vehicle according to the invention contacting select power terminals when power is supplied; and

FIG. 7 is a sectional view of a known fuse box.

### DETAILED DESCRIPTION OF THE EMBODIMENT(S)

Hereinafter, an exemplary embodiment of the present invention will be described with reference to the accompanying drawings.

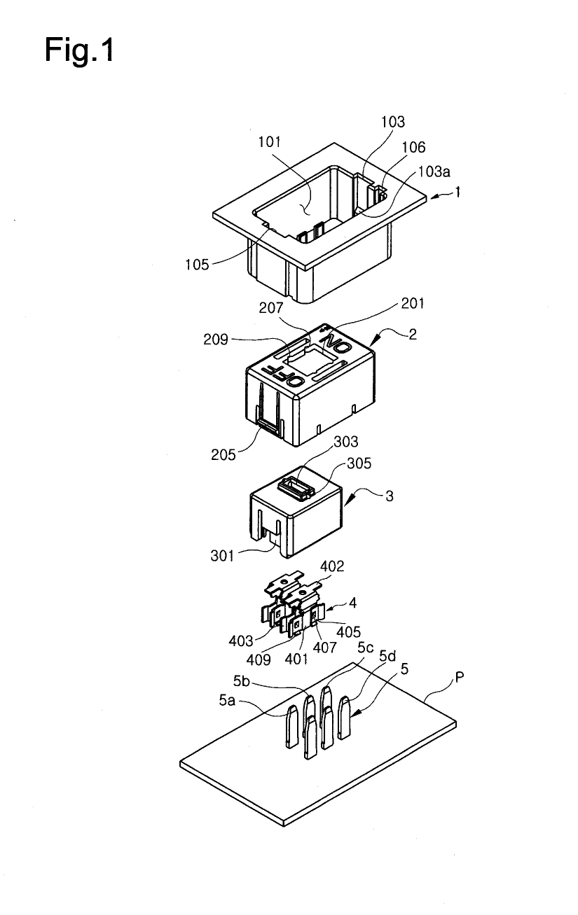

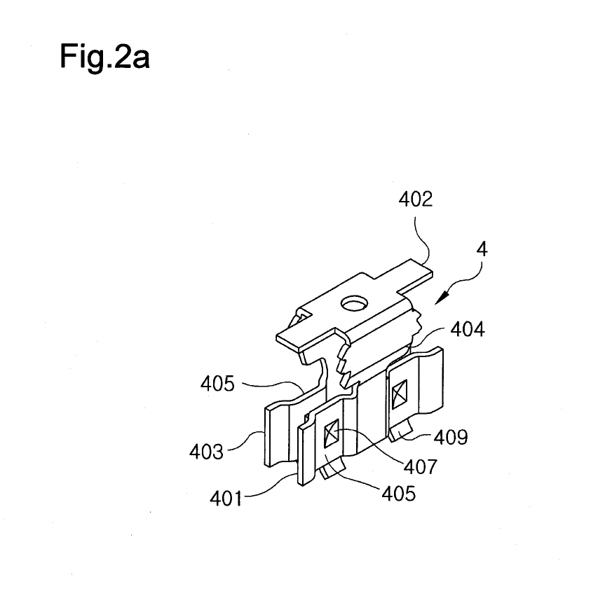

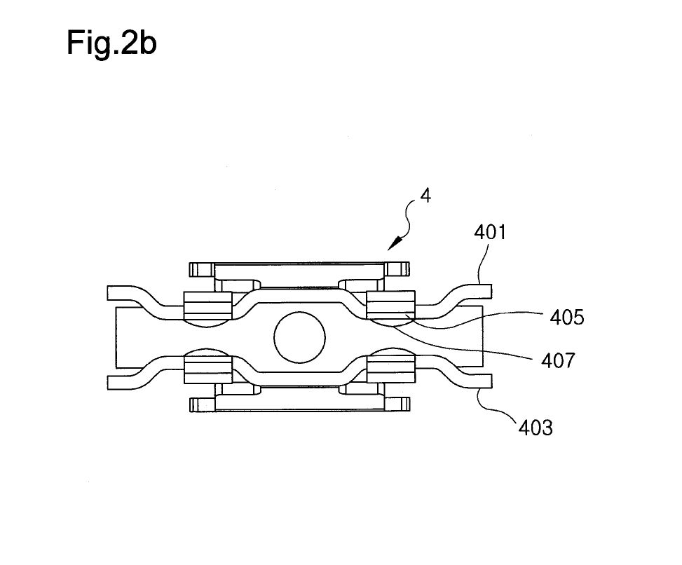

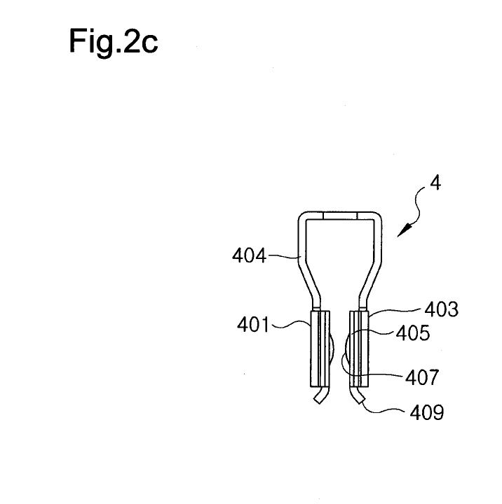

As shown in FIGS. 1 to 2c, a mode switch for the vehicle includes a power box P provided with fuses (not shown) therein, an outer housing 1 installed at an outer side of power terminals 5 for connecting or disconnecting the respective fuses, an actuator housing 2 inserted into the outer housing 1, an actuator 3 positioned inside of the actuator housing 2, and sliding contacts 4 positioned inside of the actuator 3 to be respectively connected with corresponding power terminals 5.

The outer housing 1 includes a actuator housing receiving passageway 101 for inserting the actuator housing 2 described below into the inside of the outer housing 1, while being opened at upper and lower portions thereof. The actuator housing receiving passageway 101 secures to an upper surface of the power box P on which the power terminals 5 are mounted in order to enclose the power terminals 5.

The outer housing 1 may be formed to extend inwards from or protrude outwards from the power box P according to an installation position of the mode switch. If necessary, the outer housing 1 may also be integrally formed with the power box P.

Further, the outer housing 1 is formed, at opposite sides thereof, with coupling portions 103 and 105 so as to secure the actuator housing 2.

Meanwhile, at least three power terminals 5a, 5b and 5c of the power terminals 5 protrude outwards from power box P. When first and second power terminals 5a and 5b are connected, power is applied. On the other hand, when second and third power terminals 5b and 5c are connected, power is shut off.

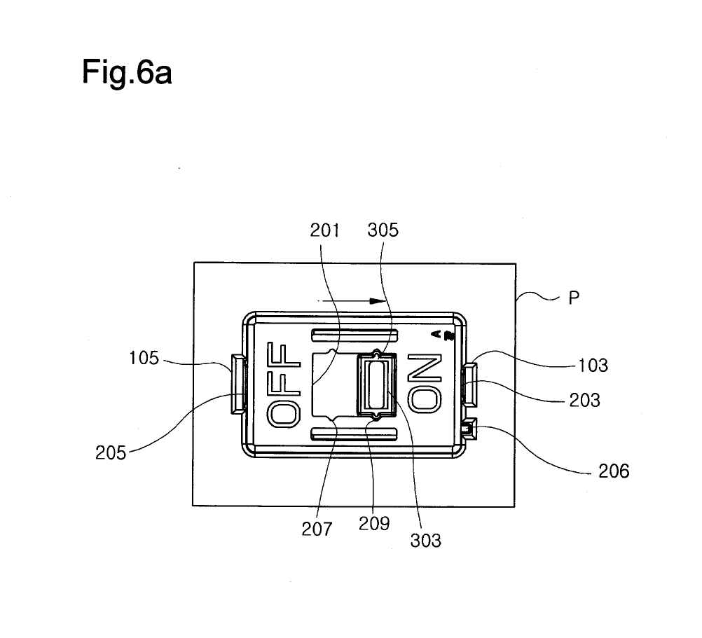

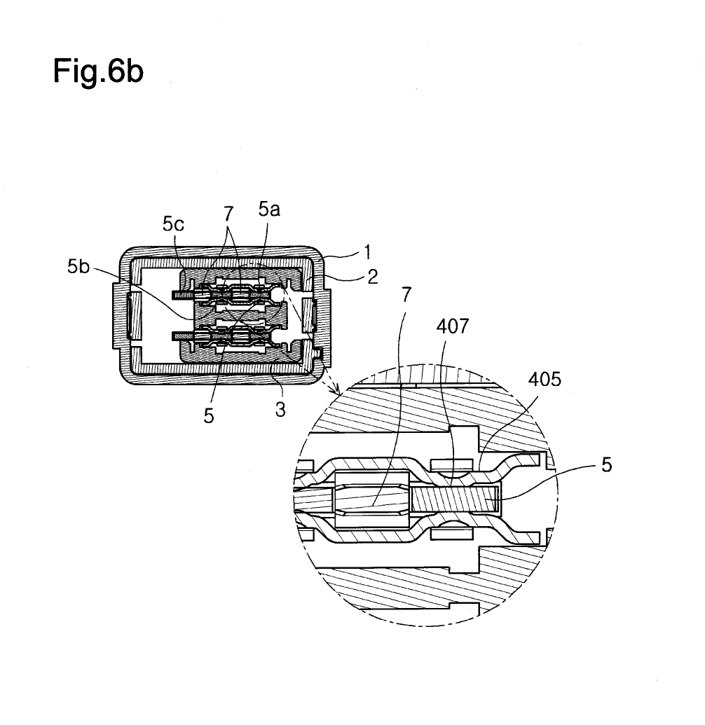

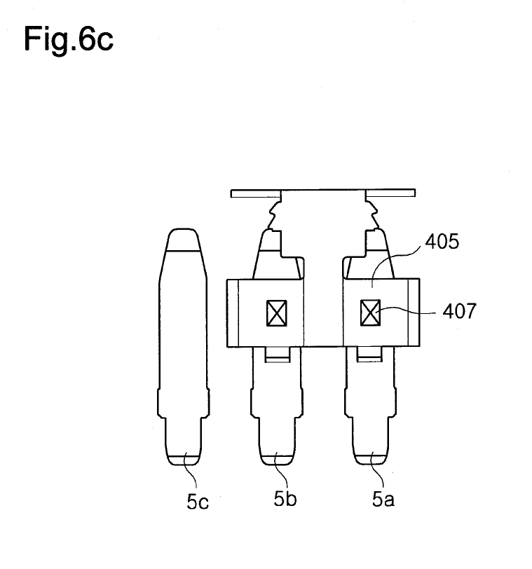

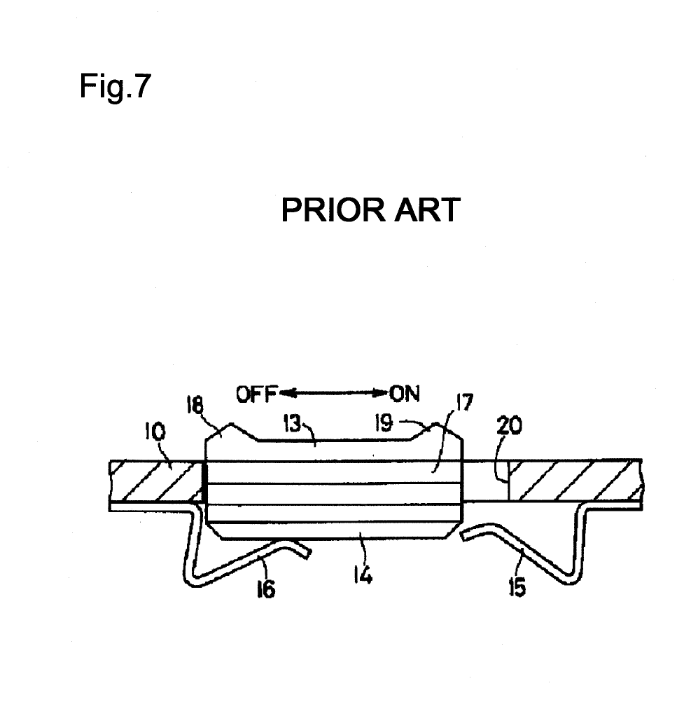

In the power box P, insulating terminals 7 are further installed between the power terminals, respectively (see FIGS. 5b and 6b). Each insulating terminal 7 is a rib which protrudes outwards from the power box P. The insulating terminal 7 is positioned between the power terminals 5, while being on the same surface as the power terminals 5.

The insulating terminal 7 guides lateral movement of each sliding contact 4 described below, while also insulating between the power terminals 5.

In the embodiment shown, the actuator housing 2 has a box shape while being opened at a lower portion thereof. The actuator housing 2 includes display signs positioned at opposite sides along an upper surface of the actuator housing 2. In other words, the display signs, which are respectively displayed as ON when power is applied and OFF when power is shut off, serve to indicate whether or not power is applied according to the connection between each sliding contact 4 and the corresponding power terminals 5.

Also, the actuator housing 2 includes a protuberance receiving passageway 201 positioned along the upper surface thereof, wherein the protuberance receiving passageway 201 receives a protuberance 303 of the actuator 3 described below. The protuberance receiving passageway 201 further includes the stopper grooves 207 and 209 that extend from the protuberance receiving passageway 201.

The stopper grooves 207 and 209 may be respectively positioned at opposite sides of the protuberance receiving passageway 201. Consequently, the protuberance 303 may be fixed to each position for applying and shutting off power.

The protuberance receiving passageway 201 has a length in which the protuberance 303 may be moved from one side of the protuberance receiving passageway 201 to the other side thereof or in the reverse direction. Consequently, each sliding contact 4 described below connects the first and second power terminals 5a and 5b, or the second and third power terminals 5b and 5c.

Meanwhile, the actuator 3 described below is inserted into the inside of the actuator housing 2 through the lower portion thereof. The actuator housing 2 is inserted into the actuator housing receiving passageway 101 of the outer housing 1.

The actuator housing 2 includes coupling protuberances 203 and 205 positioned along outer opposite sides thereof. The coupling protuberances 203 and 205 are respectively coupled to the corresponding coupling portions 103 and 105 formed along the opposite sides of the outer housing 1.

Each of the coupling portion 103 and the coupling protuberance 203 has a size different from each of the corresponding coupling portion 105 and coupling protuberance 205. The actuator housing 2 includes a guide protrusion 206 positioned along an outer surface of the actuator housing 2 and extending from the upper portion of the actuator housing 2 to the lower portion thereof while protruding outwards. The outer housing 1 further includes a guide groove 106 for inserting the guide protrusion 206. As a result, the guide groove 106 may allow the actuator housing 2 to be inserted into the outer housing 1.

In detail, each of the coupling portion 103 and the coupling protuberance 203 located at the ON display sign side has a length shorter than each of the corresponding coupling portion 105 and coupling protuberance 205 located at the OFF display sign side. When the outer housing 1 and the actuator housing 2 are coupled to each other in the reverse direction, the protuberance 303 may be located at the ON display sign side of the actuator housing 2 unlike an actual position, namely, the OFF display sign side of the protuberance 303. Thus, in accordance with the above-mentioned configuration, it may be possible to prevent power from being shut off due to incorrect coupling between the outer housing 1 and the actuator housing 2.

Accordingly, when a worker inserts the actuator housing 2 into the actuator housing receiving passageway 101 of the outer housing 1, the worker may couple each sliding contact 4 and the corresponding power terminals 5 by identification of the lengths of the coupling portion 103, 105 and the coupling protuberance 203, 205 and insertion of the guide protrusion 206 into the guide groove 106.

In the embodiment shown, the actuator 3 has a box shape while being opened at a lower portion thereof. The actuator 3 is inserted into the inside of the actuator housing 2 through the lower portion thereof. The actuator 3 is formed, at an upper surface thereof, with the protuberance 303 inserted into the protuberance receiving passageway 201 of the actuator housing 2. The protuberance 303 protrudes upward. The protuberance 303 includes stoppers 305 which are respectively inserted into the corresponding stopper grooves 207 or 209 positioned along the protuberance receiving passageway 201. The stoppers 305 are respectively positioned at opposite sides of the protuberance 303, thereby preventing unintended movement of the protuberance 303 generated due to being easily urged.

Also, the actuator 3 includes terminal mounting portions 301 along the inside of the actuator 3, at which the respective sliding contacts 4 described below are inserted and mounted.

As shown in FIG. 2a, each sliding contact 4 includes a mounting piece 402 which is inserted and mounted at the corresponding terminal mounting portion 301 of the actuator 3, and contacts 401 and 403 which are bent to respectively have “C” shapes around the mounting piece 402. In the sliding contact 4, the contacts 401 and 403 are configured to be perpendicular to the mounting piece 402. Thus, the power terminals 5 are inserted into the inside of the corresponding sliding contact 4 so that the sliding contact 4 encloses both surfaces of each power terminal 5.

The contacts 401 and 403 are integrally formed with each other by extending pieces 404 which are respectively formed at opposite sides of the mounting piece 402.

Each extending piece 404 is slanted so that a distance between the contacts 401 and 403 is narrower than a width of the mounting piece 402. Further, the extending piece 404 has a length shorter than the mounting piece 402, or the contact 401 or 403. Consequently, a portion cut between each extending piece 404 and the terminal piece 401 or 403 is formed, thereby generating elastic force between the contacts 401 and 403.

The distance between the contacts 401 and 403 is narrower than the width of the mounting piece 402 which generates elastic force between the contacts 401 and 403 through the extending piece 404 having the length shorter than each terminal piece 401 or 403. Thus, when the power terminals 5 are inserted into the corresponding sliding contact 4, the power terminals 5 are press-fit to the sliding contact 4. As a result, the connection force between the sliding contact 4 and the corresponding power terminals 5 is increased while facilitating lateral movement of the sliding contact 4.

Referring to FIGS. 2a, 2b, and 2c, the contacts 401 and 403 of each sliding contact 4 are formed, at facing sides thereof. The contacts 401 and 403 are connection portions between the sliding contact 4 and the corresponding power terminals 5, and include with bent portions 405 which are bent inwards, respectively. In this case, the sliding contact 4 comes into contact with the first and second power terminals 5a and 5b, or comes into contact with the second and third power terminals 5b and 5c. Therefore, at least two bent portions 405 may be formed along each terminal piece 401 or 403 according to a proper arrangement between the power terminals 5, in the embodiment shown.

Each bent portion 405 further includes a recessed portion 407, which is recessed inwards from the sliding contact 4. The recessed portions 407 are slightly formed along facing surfaces of the contacts 401 and 403, respectively. Each recessed portion 407 has a convex shape to generate elastic force.

As shown in FIGS. 2a, 2b, and 2c, the contacts 401 and 403 of each sliding contact 4 include tapered guides 409 positioned at lower portions thereof respectively. The tapered guides 409 expand outwards.

On the other hand, each power terminal 5 includes a tapered portion 5d positioned at an end of each power terminal 5, and narrows towards the end thereof. Consequently, the power terminal 5 may be easily inserted into the corresponding sliding contact 4 through the tapered guide 409.

The tapered guide 409 of each sliding contact 4 serves to guide insertion of the power terminal 5 at which the corresponding tapered portion 5d is formed.

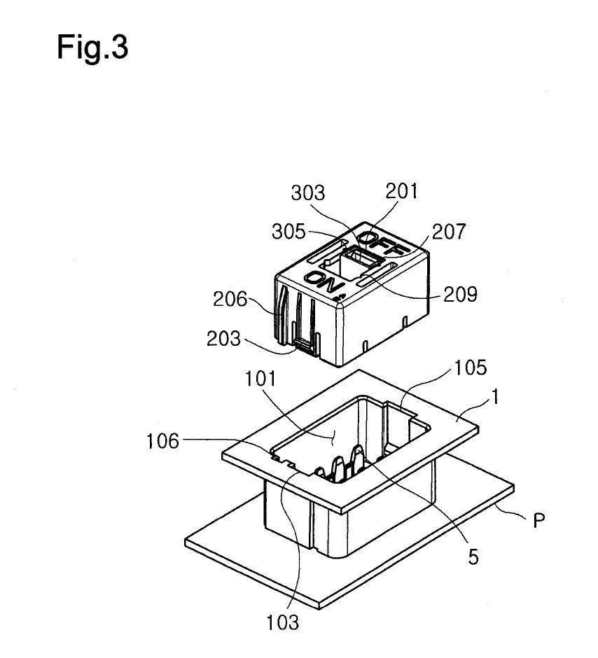

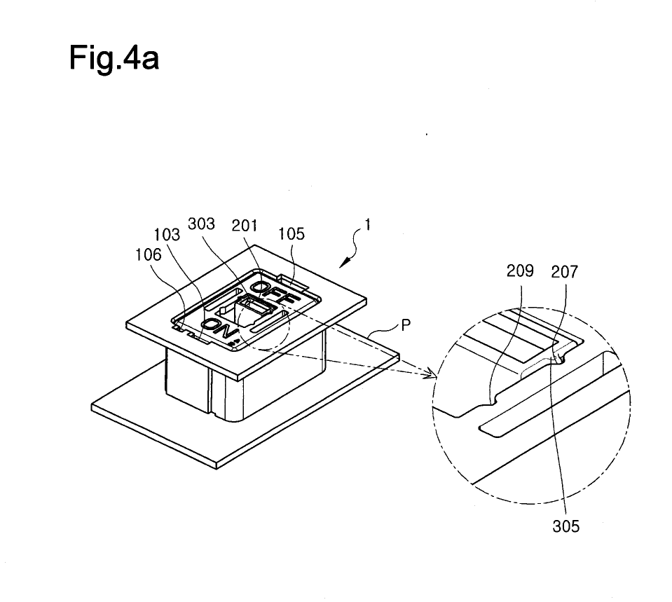

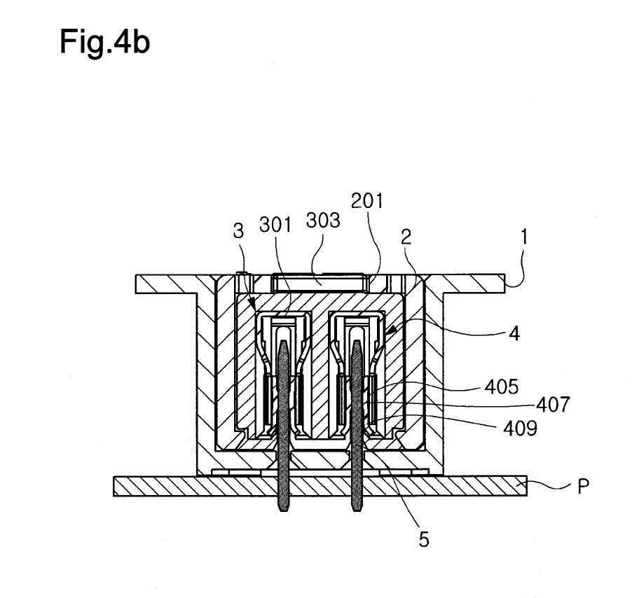

As shown in FIGS. 3 to 4b, the outer housing 1 is installed at the power box P provided with the power terminals 5 so as to enclose the power terminals 5. The actuator 3 is inserted in a state in which each sliding contact 4 is mounted at the corresponding terminal mounting portion 301 of the actuator 3 so that the protuberance 303 is inserted into the protuberance receiving passageway 201 of the actuator housing 2.

The coupling protuberance 203 having a short length and the coupling protuberance 205 having a long length are inserted into the corresponding coupling portions 103 and 105, respectively. Thus, the actuator housing 2 including the actuator 3 is inserted into the actuator housing receiving passageway 101 of the outer housing 1 so as to be coupled to the outer housing 1.

In this case, the coupling protuberance 203 having the short length is located at the ON display sign side. Therefore, when the coupling protuberances 203 and 205 are respectively coupled to the corresponding coupling portions 103 and 105 in the above-mentioned state, the first and third power terminals 5a and 5c are respectively located at the ON and OFF display sign sides.

As shown in FIG. 4a, the guide protrusion 206 of the actuator housing 2 guides coupling between the actuator housing 2 and the outer housing 1 while being inserted into the guide groove 106 of the outer housing 1. Consequently, the actuator housing 2 may be smoothly and correctly coupled to the outer housing 1.

Also, the end having the tapered portion 5d in each power terminal 5 is guided by the tapered guide 409 positioned along the lower portion of the corresponding sliding contact 4 so that the power terminal 5 is smoothly inserted into the sliding contact 4.

Subsequently, as shown in FIG. 4b, each power terminal 5 presses the corresponding recessed portions 407 when being inserted between the contacts 401 and 403, thereby coming into contact with the contacts 401 and 403 by the bent portions 405.

In an initial state, it may be preferable that the mode switch is assembled in a state in which power is shut off by inserting the protuberance 303 to be located at the OFF display sign side.

Hereinafter, the operation of the mode switch for the vehicle according to an exemplary embodiment of the invention will be described with reference to the accompanying drawings.

As shown in FIGS. 5a to 6c, the protuberance 303 is positioned at the OFF display sign side in an initial state in which the mode switch is assembled. In this case, the stoppers 305 extending from the protuberance 303 are inserted into the stopper grooves 207 at the OFF display sign side formed at the protuberance receiving passageway 201, respectively.

Referring to FIGS. 5b and 5c, when the protuberance 303 is located at the OFF display sign side, each sliding contact 4 is positioned to be connected with the second and third power terminals 5b and 5c. In this case, the second and third power terminals 5b and 5c are connected to the sliding contact 4 by the corresponding bent portions 405 and recessed portions 407.

Consequently, power of the mode switch is shut off to shut off power supply to all electronic devices mounted in the vehicle.

On the other hand, as shown in FIG. 6a, the protuberance 303 is urged so that the stoppers 305 of the protuberance 303 are emerged from the stopper grooves 207 at the OFF display sign side. Subsequently, the protuberance 303 is urged to the ON display sign side so that the stoppers 305 are respectively inserted into the stopper grooves 209 at the ON display sign side.

As shown in FIGS. 6b and 6c, each sliding contact 4 mounted at the actuator 3 is then moved in a left direction, so that the sliding contact 4 connects the first and second power terminals 5a and 5b while passing through the insulating terminals 7.

In this case, each insulating terminal 7 serves to guide movement of the sliding contact 4 together with the corresponding power terminal 5. In particular, when the sliding contact 4 is moved from the third power terminal 5c to the first power terminal 5a, the corresponding power terminals 5 and insulating terminals 7 mounted at the same line as the power terminals 5 pressurize the recessed portions 407. Consequently, the sliding contact 4 is departed from the third power terminal 5c to come into contact with the corresponding first and second power terminals 5a and 5b, bent portions 405, and recessed portions 407.

As a result, power of the mode switch is applied so that power is supplied to all electronic devices mounted in the vehicle. Therefore, the electronic devices may be normally operated.

As is apparent from the above description, the invention provides a mode switch for a vehicle with a sliding contact 4 enclosing both surfaces of the power terminal 5, and the actuator 3 at which the sliding contact 4 is mounted to be laterally moved from one side of the actuator housing 2 to the other side thereof or in the reverse direction. As a result, deformation of the sliding contact 4 is minimized, while life of the mode switch is increased.

Also, in accordance with the invention, the sliding contact 4 comes into contact with both surfaces of the power terminal 5 since the sliding contact 4 is elastically deformed, so that the power terminal 5 may be easily inserted and retained when the power terminal 5 is inserted between the contacts of the sliding contact 4. Also, the sliding contact 4 is designed such that it may be easily moved in left and right directions.

In particular, in accordance with the invention, the sliding contact 4 includes the bent portion 405 which is bent to the power terminal 5 side, and the bent portion 405 is further formed with the recessed portion 407. Thus, connection between the sliding contact 4 and the power terminal 5 may be facilitated. Also, even when a clearance between the contacts 401 and 403 due to deformation the sliding contact 4 is increased, the sliding contact 4 and the power terminal 5 may be securely connected, thereby reducing poor connection.

Further, in accordance with the invention, the lower portion of the sliding contact 4 is formed with the tapered guide 409 which expands outwards. Thus, when the mode switch is initially assembled, the power terminal 5 may be guided by the tapered guide 409 so that the power terminal 5 is smoothly inserted between the contacts 401 and 403. Therefore, it may be possible to prevent the sliding contact 4 from be deformed and damaged during insertion of the power terminal 5.

Further, in accordance with the invention, the protuberance 303 for allowing the sliding contact 4 and the power terminal 5 to be connected or disconnected is designed such that it may be inserted into the protuberance receiving passageway 201. Here, the protuberance receiving passageway 201 is not provided with any open space, thereby preventing foreign materials from being introduced through the opened space while preventing poor connection. The protuberance receiving passageway 201 includes the stopper groove, and the protuberance 303 further includes the stopper 303. Accordingly, unintended movement of the protuberance 303 to one side of the protuberance receiving passageway 201 or the other side thereof may be prevented in a connection state or a disconnection state between the sliding contact 4 and the power terminal 5, thereby preventing malfunction of the mode switch.

Further, in accordance with the invention, the coupling protuberance 203, 205 and coupling portion 103, 105 for coupling the actuator housing 2 and the outer housing 1 are sized different from each other, and the actuator housing 2 further includes the guide protrusion 206. Thus, when the mode switch is assembled, it may possible to prevent the outer housing 1 and the actuator housing 2 from being coupled to each other in the reverse direction. Therefore, exact assembly may be achieved while preventing malfunction of the mode switch, thereby exactly performing all functions of the mode switch.

Although certain embodiments of the invention have been disclosed for illustrative purposes, those skilled in the art will appreciate that various modifications, additions and substitutions are possible, without departing from the scope and spirit of the invention as disclosed in the accompanying claims.

What is claimed is:

1. A mode switch for a vehicle, comprising:
an outer housing; an actuator housing secured to the outer housing and having a display; an actuator mounted along an inside of the actuator housing and movable between one side of the actuator housing and another side thereof, the actuator having a terminal mounting portion; and a sliding contact secured to the terminal mounting portion.

2. The mode switch according to claim 1, wherein the sliding contact includes a mounting piece secured to the terminal mounting portion.

3. The mode switch according to claim 2, wherein the sliding contact further includes a first contact extending from the mounting piece.

4. The mode switch according to claim 3, wherein the sliding contact further includes a second contact extending from the mounting piece, the first contact facing the second contact.

5. The mode switch according to claim 4, wherein the mounting piece, first contact and second contact are integrally formed with one another by extending pieces which are respectively formed at opposite sides of the mounting piece.

6. The mode switch for the vehicle according to claim 5, wherein each extending piece bends inward such that a width between first and second contacts is smaller than a mounting piece width.

7. The mode switch according to claim 6, wherein each extending piece is shorter in length than the mounting piece, the first contact, and the second contact.

8. The mode switch according to claim 6, wherein the first and second contacts include bent portions which bend inwards from respective surfaces.

9. The mode switch according to claim 8, wherein each bent portion includes a recessed portion which is recessed inwards from the corresponding surface.

10. The mode switch according to claim 4, wherein the first contact and second contact include tapered guides which expanded outwards from the respective surfaces and positioned along a bottom edge of the first and second contacts.

11. The mode switch according to claim 1, wherein the actuator includes a protuberance positioned on an upper surface of the actuator.

12. The mode switch according to claim 11, wherein the protuberance includes stoppers protruding outwards from the protuberance.

13. The mode switch for the vehicle according to claim 12, wherein the actuator housing includes a protuberance receiving passageway that receives the protuberance and includes space so that the protuberance is movable from one side of the protuberance receiving passageway to another side thereof.

14. The mode switch according to claim 13, wherein the protuberance receiving passageway includes stopper groves positioned at opposite sides of the protuberance receiving passageway and to which the corresponding stoppers are respectively inserted so as to correspond to a position in which the sliding contact is connected with or is disconnected.

15. The mode switch according to claim 1, wherein the actuator housing includes coupling protuberances positioned at outer opposite sides of the actuator housing and are inserted into and secured to an inside of the outer housing.

16. The mode switch according to claim 15, wherein the coupling protuberances are sized differently from each other.

17. The mode switch according to claim 16, wherein the actuator housing includes a guide protrusion positioned at an outer surface of the actuator housing and extending from an upper portion to a lower portion of the actuator housing while also protruding outwards.

18. The mode switch according to claim 17, wherein the outer housing includes a guide groove for inserting the guide protrusion.
